(19) United States
(12) Patent Application Publication
(10) Pub. No.: US 2018/0324271 A1
(43) Pub. Date: Nov. 8, 2018

(54) METHOD AND APPARATUS FOR CACHING IN A COMMUNICATION NETWORK

(71) Applicant: Philippe Leroux, Ottawa (CA)

(72) Inventor: Philippe Leroux, Ottawa (CA)

(73) Assignee: Huawei Technologies Co., Ltd., Shenzhen (CN)

(21) Appl. No.: 15/584,837

(22) Filed: May 2, 2017

(51) Int. Cl. H04L 29/08; G06F 12/0888; G06F 17/30

(52) U.S. Cl. CPC H04L 67/2842; H04L 67/101; G06F 17/30902; H04L 67/02; G06F 12/0888; H04L 67/1008

(57) ABSTRACT

Methods and apparatus for evaluating caching in a communication network are disclosed. According to embodiments, the methods and apparatus provide for dynamic evaluation of caching in a communication network, wherein a cost associated with the caching can be indicative of dynamic communication network resource demands. According to embodiments, the methods and apparatus of the instant application provide an application server is provided with a cost profile which relates to one or more of the cost of caching and the cost of link usage. The application server can thereby strategically determine how to provide the desired level of user equipment service while mitigating the cost associated with the provision of same.

### FIELD OF THE INVENTION

The present invention pertains to the field communication networks and in particular to a method and apparatus for caching in a communication network.

### BACKGROUND

As is known caching data can provide improved performance for systems, for example caching of website data on a computing device for later use when the site is subsequently accessed can improve responsiveness.

There are also caching proxy servers, for example Squid. This caching proxy server can support protocols including HTTP, FTP, and more and can reduce bandwidth consumption and improve response times by caching and reusing frequently-requested web pages. Squid can optimise the data flow between a user equipment and a server to improve performance and can cache frequently-used content to save bandwidth. Squid can also route content requests to servers in a wide variety of ways to build cache server hierarchies which may optimise network throughput.

Network operators are unable to identify information that may be suitable for caching due to the encryption of this information during transmission from an application server, for example a Netflix server, to the user equipment. As such, presently operators provide a caching service to an application server which can enable the operators to provide a desired level of responsiveness of their communication systems. However, mitigation of costs to a network operator which are associated with caching is desired.

Therefore there is a need for a method and apparatus for evaluating caching in a communication network that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for caching in a communication network. In accordance with an aspect of the present invention, there is provided a method for caching in a communication network. The method includes transmitting a cost profile indicative of one or more of a cost associated with cache usage and a cost associated with communication link usage.

In some embodiments, the method further includes receiving one or more of network operational parameters indicative of utilization of a communication link associated the communication network and cache usage parameters indicative of utilization of cache associated with the communication network. In some embodiments, the method further includes determining the cost profile based at least in part on one or more of the network operational parameters and the cache usage parameters.

In accordance with another aspect of the present invention which can be combined with any of the preceding embodiments, there is provided a method for caching in a communication network. The method includes monitoring the communication network to determine network operational parameters and monitoring usage of cache associated with the communication network to determine cache usage parameters. The method further includes determining a cost profile for cache usage, wherein the cost profile based at least in part on the network operational parameters or cache usage parameters or both and transmitting the cost profile for cache usage.

In accordance with another aspect of the present invention which can be combined with any of the preceding embodiments, there is provided a method for caching in a communication network. The method includes receiving a cost profile for cache usage, the cost profile indicative of network operational parameters associated with the communication network or cache usage parameters indicative of usage of cache associated with the communication network or both. The method further includes determining if caching of data is required, wherein determining is based at least in part on the cost profile.

In accordance with another aspect of the present invention which can be combined with any of the preceding embodiments, there is provided a device for caching in a communication network. The device a processor and machine readable memory storing machine executable instructions which when executed by the processor configure the device to monitor the communication network to determine network operational parameters and monitor usage of cache associated with the communication network to determine cache usage parameters. The machine executable instructions further configure the device to determine a cost profile for cache usage, wherein the cost profile based at least in part on the network operational parameters or cache usage parameters or both and transmit the cost profile for cache usage.

In accordance with another aspect of the present invention which can be combined with any of the preceding embodiments, there is provided a device for caching in a communication network. The device includes a processor and machine readable memory storing machine executable instructions which when executed by the processor configure the device to receive a cost profile for cache usage, the cost profile indicative of network operational parameters associated with the communication network or cache usage parameters indicative of usage of cache associated with the communication network or both. The machine executable instructions further configure the device to determine if caching of data is required, wherein determining is based at least in part on the cost profile.

In accordance with another aspect of the present invention which can be combined with any of the preceding embodiments, there is provided a method for evaluating use of a network function in a communication network. The method includes transmitting a cost profile indicative of a cost associated network function usage.

In some embodiments which can be combined with any of the preceding embodiments, the method further includes monitoring the communication network to determine network operational parameters and evaluating usage of the network function associated with the communication network to determine network function usage parameters. In some embodiments, the method further includes determining the cost profile based at least in part on the network operational parameters or network function usage parameters or both.

### BRIEF DESCRIPTION OF THE FIGURES

Further features and advantages of the present invention will become apparent from the following detailed description, taken in combination with the appended drawings, in which:

FIG. 1 illustrates communication network connectivity between an application server and a user equipment according to embodiments of the present invention.

FIG. 2A illustrates communication network connectivity between an application server and a communication network according to embodiments of the present invention.

FIG. 2B illustrates communication network connectivity between an application server and a communication network according to embodiments of the present invention.

FIG. 2C illustrates communication network connectivity between an application server and a communication network according to embodiments of the present invention.

FIG. 3 illustrates a signalling diagram for an interaction between a communication network and an application server, in accordance with embodiments of the present invention.

FIG. 4 illustrates a cache management component integrated within a communication network, the cache management component configured in accordance with embodiments of the present invention.

FIG. 5 illustrates a method for caching in a communication network in accordance with embodiments of the present invention.

FIG. 6 illustrates a method for caching in a communication network in accordance with embodiments of the present invention.

FIG. 7 illustrates a method for evaluating use of a network function in a communication network in accordance with embodiments of the present invention.

FIG. 8 is a schematic diagram of a hardware device, according to an embodiment of the present invention.

It will be noted that throughout the appended drawings, like features are identified by like reference numerals.

### DETAILED DESCRIPTION OF THE INVENTION

It has been realised that the caching provided by an operator of a communication network has an associated cost therewith. The mitigation of this cost born by the operator is desired. The present invention provides methods and apparatus for evaluating caching in a communication network. According to embodiments, the methods and apparatus provide for dynamic evaluation of caching in a communication network, wherein a cost associated with the caching can be indicative of dynamic communication network resource demands. The communication resource demands can be representative of bandwidth demands or bandwidth limitations or storage demands or storage limitations or a combination thereof. According to embodiments, the methods and apparatus of the instant application provide an application server with the ability to determine if caching is necessary in order for one or more intended user equipments (UEs) or electronic devices (EDs) to receive a desired level of service while also mitigating costs to the application server associated with the provision of the service. The term user equipment and electronic device are used interchangeably in this description.

As an example, a particular user equipment may require a desired level of responsiveness to information requests from an application server and this responsiveness can be dependent on bandwidth considerations and caching considerations associated with the communication network that links the application server to the user equipment. An operator which provides this service linking the application server and the user equipment requesting a service from the application server is desirous of mitigating the costs associated therewith and can provide the application server with a dynamic form of costing for the provision of the service based on bandwidth and caching. This dynamic costing can be based on an at least partly real-time determination of communication network loading and availability of caching resources. The application server can be provided with a cost profile which relates to one or more of the cost of caching and the cost of link usage. In some embodiments, the application server can be provided with information relating to this determination of communication network loading and caching availability and the associated costs therewith. The application server can thereby strategically determine how to provide the desired level of user equipment service while mitigating the cost associated with the provision of same.

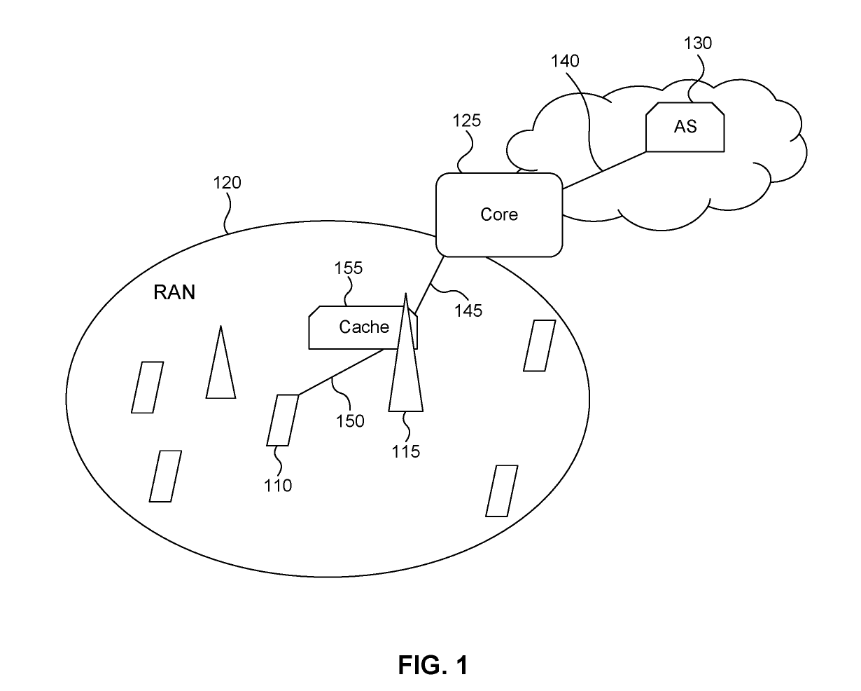

With the ever increasing bandwidth provided by over the air (OTA) wireless connectivity, the backhaul and fronthaul portions of communication networks can become a limiting factor for providing a desired level of service between an Application Server (AS) and a user equipment or electronic device. FIG. 1 illustrates communication network connectivity between an Application Server (AS) and a user equipment (UE) according to embodiments of the present invention. The AS 130 is connected to the core network 125 of the communication network via link 140 and the core network 125 is connected to a radio access network (RAN) 120 provided by a public mobile network operator (PMNO) and in particular access point (AP) 115 via link 145. The access point 115 provides the connection to the UE 110 via link 150. In this illustrated embodiment, the application server 130 is provided with an option to cache information likely to be requested by the UE 110 proximate to the access point in a cache 155 provided by the PMNO 120. In this manner the application server can provide the UE with this likely requested information in a more expedited manner substantially without a potential limitation based on the limiting link 145. According to embodiments, the application server can be provided with information relating to bandwidth and caching details. For example, this information can relate to one or more of the cost of caching and the cost of link usage. As another example, this information can relate to bandwidth limitations regarding the limiting link 145 as well as a cost profile associated with the caching of the information at the cache 155. This information can provide the application server with the ability to determine what data to cache and when to cache this data, in light of the cost involved with caching.

According to embodiments, a cost profile can be indicative of backhaul usage and costs associated therewith, while also being indicative of cache usage and the costs associated therewith This cost profile can provide an application server with details relating to associated costs with using backhaul bandwidth and the cost associated with caching information. As such, the cost profile can provide an application server with parameters to determine an acceptable trade-off between the usage of cache or backhaul bandwidth usage or a combination thereof. This acceptable trade-off may further be dependent on the expected service to be provided to the user equipment that is requesting data from the application server. Moreover, the cost profile can further provide details relating to dynamic changes in the communication network for example relating to cache usage and bandwidth usage and availability. These dynamic changes may be indicative of passed usage, timing of usage, amount of usage and the like as these usage parameters relate to bandwidth or cache or both.

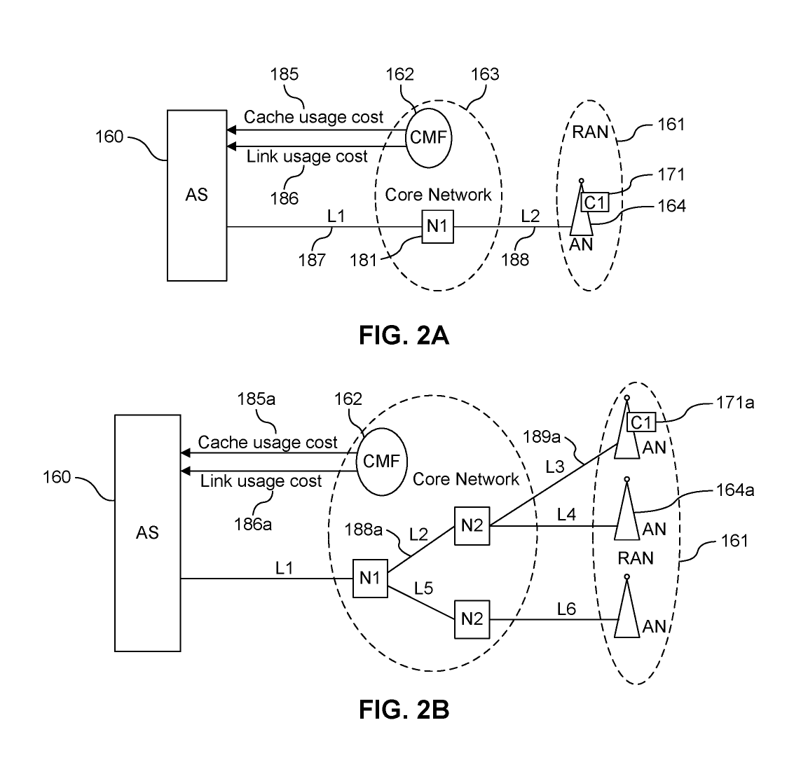

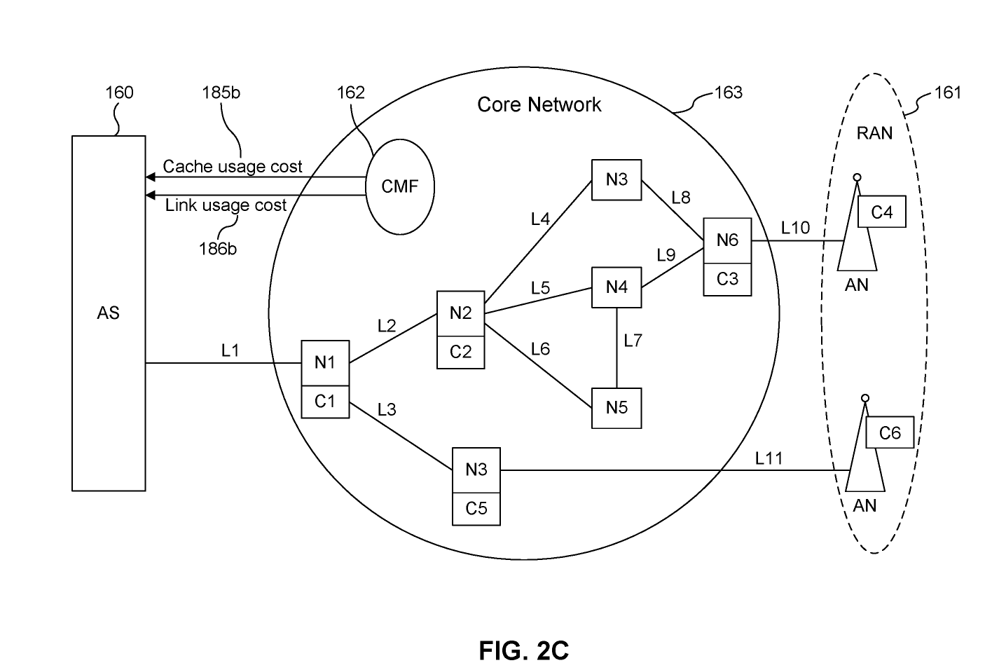

FIGS. 2A to 2C illustrate a cache management component integrated within a communication network, the cache management component providing the functionality of a cache management function (CMF) configured in accordance with embodiments of the present invention. According to embodiments, the cache management component utilizes real computer resources or virtual computer resources or both, in order to provide the functionality of a cache management function (CMF). It is understood that such computer resources utilize, at a hardware level, a set of one or more microprocessors operatively coupled to a corresponding set of memory components which include stored program instructions for execution by the one or more microprocessors.

FIG. 2A illustrates communication network connectivity between an application server and a communication network according to embodiments of the present invention. In this configuration, the application server (AS) 160. In FIG. 2 the AS 160 is connected to a radio access network (RAN) 161 through a core network 163. Within the RAN 161 there is at least one access node (AN) 164 that has a cache C1 171 associated therewith. In some instances the at least one access node can be a radio node. In the illustrated embodiment, AN 164 is connected to a node N1 181 within the core network 163 via link L2 188 and node N1 181 is subsequently connected to the AS 160 via link L1 187.

According to embodiments, a cost profile is transmitted to the application server in order to provide the application server with parameters to determine an acceptable trade-off between the usage of cache or backhaul bandwidth usage or a combination thereof. The cost profile can include information relating to one or more of a cost associated with cache usage 185 and a cost associated with communication link usage 186. It is understood that different communication links and different caches can have associated therewith different costs, and these different costs can be represented in the cost profile. According to embodiments, a cache management function 162, which may be resident within the core network 162, is configured to transmit the cost profile to the application server. According to some embodiments, there can be plural cost profiles transmitted to the application server, wherein each cost profile includes information indicative of one or more of cache usage cost and link usage cost. In some embodiments, the cost profiles can be indicative of one or more of updated cache usage costs and updated link usage costs.

According to embodiments, the cache usage cost can be dependent on one or more of time of use of the cache, current or future cache usage demand and historical cache usage demand. According to embodiments, the link usage costs can be dependent on one or more of time of use of the communication links, current or future communication link usage demand and historical communication link usage demand.

As previously noted, a cost profile to the application server in order to provide the application server with parameters to determine the usage of cache or backhaul bandwidth usage or a combination thereof. In order to determine the cache usage, the application server can be provided with or have access to a communication network topology, which can define cache locations and communication link configurations.

With further reference to FIG. 2A, the communication network can include the core network 163 and the RAN 161, and as such, link L1 187 may not be within operational control of the communication network. In this instance, the cost profile which includes one or more of the cache usage costs 185 and link usage costs 186 can include costs associated with the use of link L2 188 and costs associated with the use of cache C1 171.

FIG. 2B illustrates communication network connectivity between an application server and a communication network according to embodiments of the present invention. In this communication network configuration, the cost profile transmitted by the CMF 162 can include link usage costs 185a associated with the use of links L2 to L6 and cache usage costs 186a associated with the use of cache C1. In the illustrated communication network configuration, only link L2 188a and L3 189a provide a path to the cache C1 171a, and as such in some embodiments only the costs associated with these links may be included in the cost profile. However, in some embodiments, the costs associated with the other links, namely L4 to L6, may be included in the cost profile. For example, if an alternate cache became available at another access node 164a, an alternate link set would be required for the application server to connect with that alternate cache.

FIG. 2C illustrates communication network connectivity between an application server and a communication network according to embodiments of the present invention. In this communication network configuration, the cost profile transmitted by the CMF 162 can include link usage costs 185b associated with the use of links L2 to L11 and cache usage costs 186b associated with the use of caches C1 to C6. In this configuration, as can be identified, there are number of different routes, for example a collection of links within the communication network that connect the application server to the various caches. As such with the provision or knowledge of the communication network topology, the application server can be provided with information to determine a suitable or optimal usage of cache or backhaul bandwidth usage (e.g. link usage) or a combination thereof.

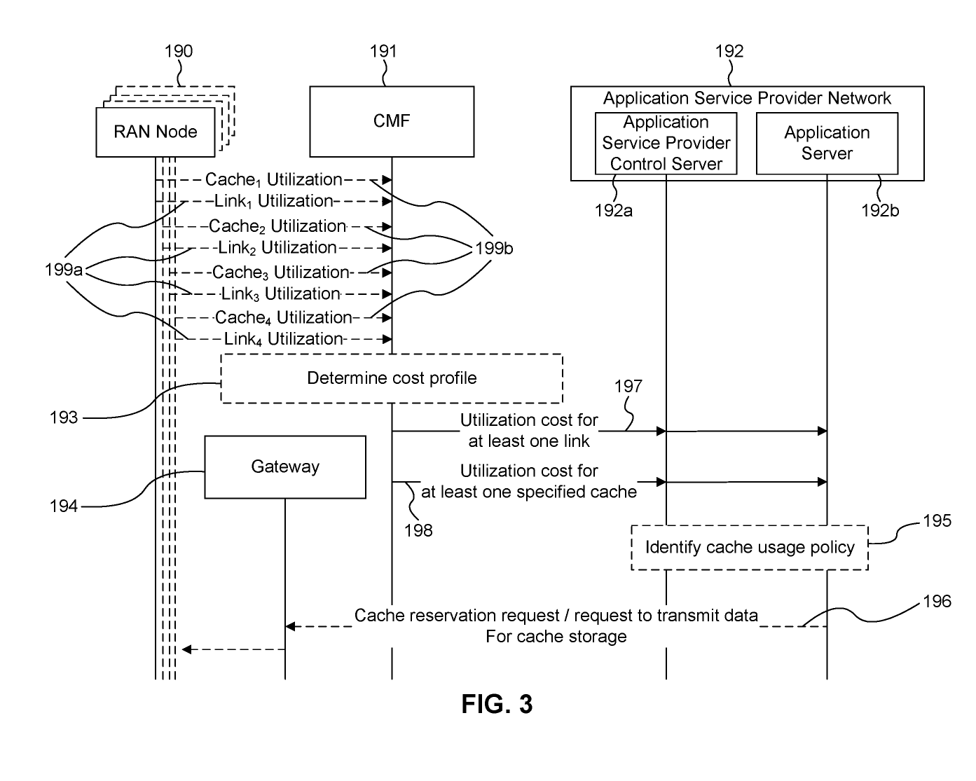

FIG. 3 illustrates a signalling diagram for an interaction between a network and an application server, in accordance with embodiments of the present invention. According to embodiments, the cache management function (CMF) 191 is configured to transmit a cost profile which can include one or more of a cost associated with cache usage 198 and a cost associated with communication link usage 197. The cost profile can be provided the application service provider network 192, for example the application service provide control server 192a and/or the application server 192b.

According to some embodiments, prior to transmitting the cost profile, the CMF 191 receives one or more of network operational parameters that can be indicative of utilization communication network link usage 199b and cache usage parameters which can be indicative of utilization of cache 199a associate with the communication network. These network operational parameters and cache usage parameters can be received from one or more RAN nodes 190 associated with the communication network.

According to some embodiments, upon receipt of the network operational parameters and/or the cache usage parameters, the CMF 191 can be configured to determine the cost profile, based on one or more of the network operational parameters and the cache operational parameters. The application service provider network 192 can subsequently access a cache usage policy 195, which together with the cost profile, can provide the application service provider network, and in particular the application service provider control server 192a and the application server 192b, with the necessary information to determine the usage of cache or backhaul bandwidth usage (e.g. link usage) or a combination thereof. Upon the determination of desired cache usage and/or link usage, the application server can transmit a cache reservation request and a request to transmit data for cache storage 196 to a gateway 194 associated with the communication network and which is communicatively linked to the one or more RAN nodes associated with the respective one or more caches of which usage thereof is desired by the application server.

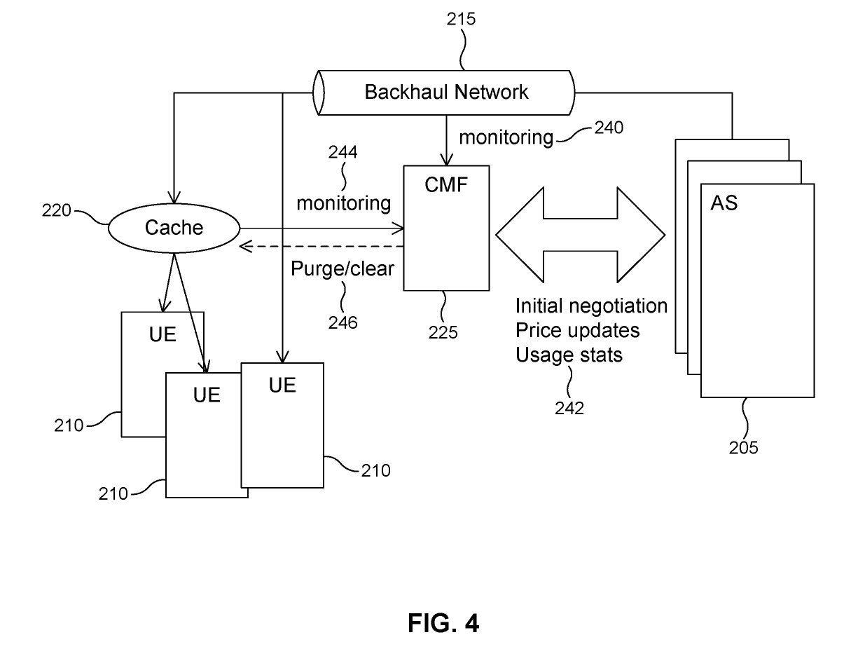

FIG. 4 illustrates a cache management component integrated within a communication network, the cache management component providing the functionality of cache management function (CMF) 225 configured in accordance with embodiments of the present invention. As illustrated, the application server (customer) 205 is linked to the user equipment or electronic device 210 via a backhaul network 215, which in some instances may have limited bandwidth or capacity depending on the usage thereof. In some instances, the application server can provide requested information to a user equipment directly from the application server through the backhaul network 215. However in other instances at least some of the requested information is stored in a cache 220 which is positioned such that the backhaul network will not impact the speed with which the requested information can be provided to the user equipment. According to embodiments, a cache management function (CMF) 225 is located within the communication network and the cache management function is configured to manage the use of the cache provided within the communication network based on requirements or requests from an application server. For example, the cache management function can provide cost profiles for cache usage to the application server, and the application server can use these cost profiles in order to suitably use the communication network resources in order to provide a level of service to a user equipment, while mitigating costs associated therewith.

According to embodiments, the cache management function is configured to monitor 240 the communication network, for example the backhaul network or fronthaul network or both, in order to determine network operational parameters, for example, bandwidth usage parameters. The cache management function can use these network operational parameters to at least in part determine a cost profile related to the use of cache locations which are provided by the public mobile network operator within the communication network.

According to embodiments, the cache management function is further configured to monitor 244 cache usage. For example, cache usage may be indicative of cache location or the amount of cache available at a location or requests for a particular cache location or a combination thereof. The cache management function can use parameters relating to cache usage to at least in part determine a cost profile related to the use of cache locations. In a further embodiment, the cost profile related to the use of cache locations are further are provided to the application server 205.

According to embodiments, one or more of the cost profiles determined by the cache management function can be provided 242 to the application server which can enable the application server to determine if the use of one or more of the caches located within the communication network is suitable. The suitability of the use of cache can be based on the one or more cost profiles, a desired service provided by the application server to the user equipment (customer) or a combination thereof. According to embodiments, the one or more cost profiles are used by the application server in order to negotiate terms of use with the cache management function for use of the cache. In some embodiments, the one or more cost profiles are dynamic and can change over time and thus the cache management function can provide updates regarding the cost profiles as changes occur.

In some embodiments, the cache management function can further provide the application server with parameters relating to cached information. For example the cache management function can monitor the one or more caches associated therewith in order to provide usage parameters indicative of the cached information associated with that application server. These cache usage parameters in association with the one or more cost profiles can provide the application server the ability to determine is further maintaining the cached information is required, for example if retaining the cached information is cost effective.

According to embodiments, cache usage parameters can be indicative of how much cache storage is being used or how much cache storage is available for use. In addition, cache usage parameters can be indicative of the frequency of access of particular information that is stored within the cache. For example, the frequency of access of particular information within the cache can be used by the application server for determination of the value of maintaining that information within the cache. In addition, it would be understood that the cache management function can also use the frequency of access of particular information for the determination or modification of a cost profile for provision to the particular application server associated with the particular information. According to embodiments, a cost profile can be indicative of cache usage parameters that include the timing of access of cached information, the duration of access to this cached information, the amount of cached information that is accessed or other parameter relating to the particular cached information. According to some embodiments, when the cache parameters are indicative of particular cached information, the cache management function can have knowledge of the particular application server with which this particular cached information is associated, and as such the cache management function can generate and provide a cost profile that is tailored to a specific application server.

In some embodiments, the cache management function can further be configured to manage the particular caches associated therewith. For example cache management function can be configured to activate cache purging or clearing 246 of a particular cache or multiple caches. For example, if an application server determines that the cost associated with continued use of one or more caches for the storage of data or particular data is no longer necessary, then the application server can instruct the cache management function to purge or clear the cache of the data or just particular data.

In some embodiments, the functions of the cache management function can be integrated into the functionality of a policy and charging rules function (PCRF). For example, the PCRF can support service data flow detection, policy enforcement and flow-based charging and thus the functionality of the cache management function can fall within the scope of functionality of the PCRF.

In some embodiments, the cache management function can be integrated into the service capability and exposure function. For example, the SCEF is configured to be capable of monitoring and providing notifications of desired events to an application server regarding a user equipment and thus the functionality of the cache management function can fall within the scope of functionality of the SCEF.

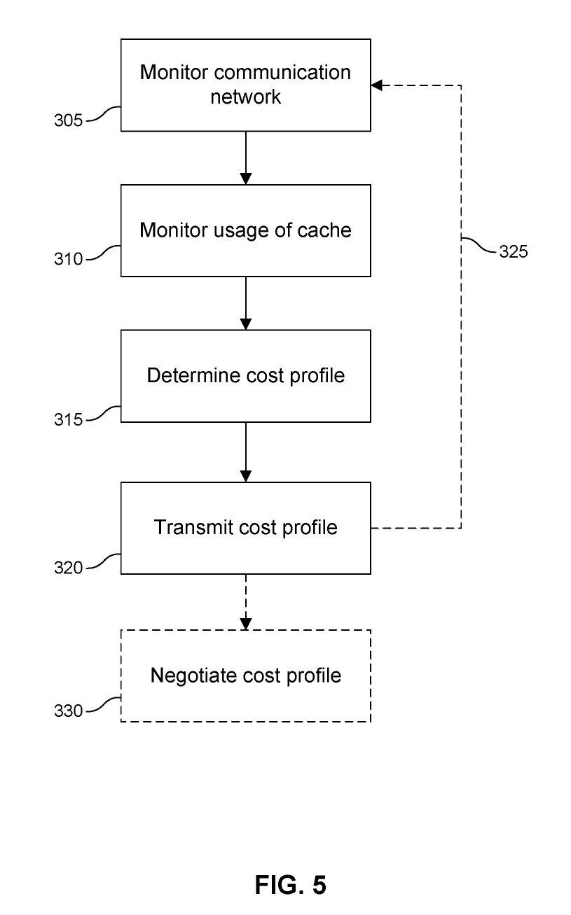

FIG. 5 illustrates a method for caching in a communication network in accordance with embodiments of the present invention. This method is defined based on actions that can be performed by the cache management function. The method includes monitoring 305 the communication network to determine network operational parameters and monitoring 310 usage of cache associated with the communication network to determine cache usage parameters. The method further includes determining 315 a cost profile for cache usage, wherein the cost profile based at least in part on the network operational parameters or cache usage parameters or both and transmitting 320 the cost profile for cache usage.

According to embodiments and with further reference to FIG. 5, the method further includes the repeating 325 of the monitoring of one or more of the communication network and the usage of cache. This repeated monitoring can result in the cache management function determining updated operational parameters or cache usage parameters which may be used for the determination of an updated cost profile. This updated cost profile can subsequently be provided to the application server in order to further determination of whether caching of data is desired thereby.

According to embodiments, the method further includes negotiating 330 by the cache management function with the application server in order to determine a suitable cost profile that is acceptable to both the cache management function and the application server. Negotiation between the application server and the cache management function can provide for adjustment to the cost profile based on considerations that may include user equipment expectations, the importance of the data that may be cached, history of use by a user equipment of the data to be cached or other factors as would be readily understood by a worker skilled in the art.

According to embodiments, negotiation the cache management function and the application server can be limited to a particular amount of time. For example, a network operator may have a limitation for how long negotiation regarding the cost profile can continue. For example the time slot for negotiation may be a few second, a few minutes, an hour or other time frame as would be readily understood. By setting a limit on the time for negotiations to proceed, there is a possibility of the negotiating application server to drop or not use the cache being negotiated, thereby opening up that cache storage for potentially higher paying application servers or customer. According to embodiments, a particular application server can have a predetermined set of rules that are associated with the negotiating of the cost profile for the use of cache and these rules can be dependent on the type of application server or the particular customer that is operating the application server. For example, the evaluation of whether to cache or not to cache particular data can be determined based on a set of rules that include parameters relating to the amount of the particular data that is likely to be accessed, the number of times that the particular data is likely to be accessed, a cost or limitation regarding the bandwidth of the backhaul and dynamic costing of caching or other rules as would be readily understood by a worker skilled in the art or combinations thereof.

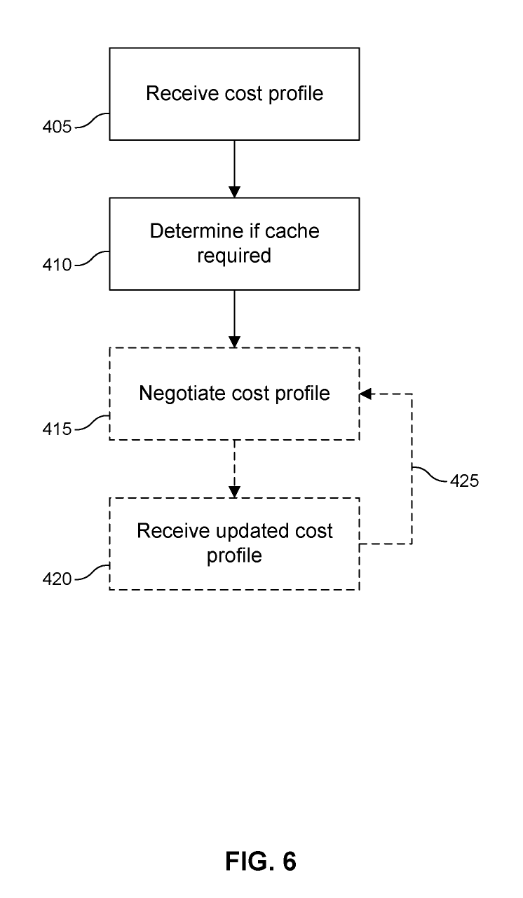

FIG. 6 illustrates a method for caching in a communication network in accordance with embodiments of the present invention. This method is defined based on action that can be performed by the application server. The method includes receiving 405 a cost profile for cache usage. In a further embodiment, the cost profile can be indicative of network operational parameters associated with the communication network or cache usage parameters indicative of usage of cache associated with the communication network or both. The method further includes determining 410 if caching of data is required, wherein determining is based at least in part on the cost profile.

According to some embodiments and with further reference to FIG. 6, the method further includes negotiating 415 with the cache management function in order to determine a suitable cost profile that is acceptable. In some embodiments, the application server may receive 420 updated cost profiles from the cache management function, wherein this updated cost profiles can be based on updated operational parameters of the communication network and updated cache usage parameters. The negotiating and reception of updated cost profiles may be repeated 425 depending on the actions performed by the cache management function.

According to embodiments, a cost profile can provide details relating to one or more of a cost associated with the transport of data from the application server to a particular cache, for example a mobile edge computing (MEC) cache; the cost of transporting the data directly from the application server to the user equipment requesting the data; and the cost of caching the data which can be dynamic in nature, for example changes over time based on availability, competition with other application servers for the same cache storage and other parameters. According to embodiments, the cost associated with transport of data from the application server can be considered to be dynamic, as the communication network resources that are required for transmitting data can vary over time. For example, this cost associated with data transmission may be lower when the backhaul network has greater available bandwidth. It is understood that available bandwidth can be dependent on the specific network resources associated with a communication network which may vary over time. Furthermore the available bandwidth can be dependent on the demand for network resources which can also vary over time.

According to embodiments, a cost profile can be configured to be static and thus provides a fixed cost associated with the use of the cache that is provided by the network operator. This fixed cost may be dependent on the amount of cache used or the length of time that the cache will be used or a combination of both.

According to embodiments, a cost profile can be configured to be dynamic such that the cost profile is changing relative to the parameters that include the communication usage, the amount of cache that is available, the location within the communication network at which the available cache is located, demands for the cache by varying application servers and other parameters as would be readily understood.

According to embodiments, a cost profile may be based on frequency of updates or other timing parameter. For example, if a cost profile is provided on a daily basis, the cost profile can configured to account for varying cost over the day, wherein these varying costs may be based on data regarding cache usage or communication network operational conditions or both that is either historical or predictive. In this manner, when cache is historically or predictively determined to be in high demand, the cost associated with the use of the cache at that time can be elevated.

According to embodiments, in determining a cost profile, the cost associated with the use of cache can be considered to be bounded by the limit of the backhaul network. In particular this can be a scenario with the improving speed of over the air communications. For example, if bandwidth provided by the backhaul is unlimited but the cost of using the backhaul network is expensive, an application server will select to use the cache for storage of a substantial amount data as this will reduce the impact of the use of the costly backhaul network. In this example, this consideration of use of the cache can be dependent on the number of time that the data stored in the cache is accessed. As another example if the amount of backhaul bandwidth is limited, cache may be used to store data at times when the backhaul network has available bandwidth. In this example, it may be considered to be cost effective to store the information in the cache even if it is accessed only one, however there is the underlying assumption that this information will in fact be accessed during a period of time when the use of the backhaul network is expensive.

According to embodiments, a cost profile can be indicative of an expected cost for cache usage or backhaul usage or both and the cost profile can be based on costs reflective of cost of passed usage or instant costs associated with current usage or guaranteed costs or a combination thereof. According to embodiments, guaranteed costs can be dependent on the amount of time cache storage is to be used, which may be negotiated in advanced between the cache management function and the application server. In some embodiments, a cost profile can be represented by one or more costs expressed as a dollar amount per bits per period of time or dollar amount per stored bits, or dollar amount per bits accessed or dollar amount based on accessed bits per stored bits or dollar amount based on accessed bits per stored bits per unit of time or other expression as would be readily understood by a worker skilled in the art, such that the expression that can be used to define a cost associated with either cache usage or bandwidth usage. According to embodiments, a cost profile can be based on costs that are defined by bits per time if it is a unit-less quantity that may be used in one or more optimization algorithms.

According to embodiments, when the operational conditions of a communication network are limited, for example the bandwidth of the backhaul of a network is limited, the cache management function can provide an application user with a means for evaluating the quality of experience (QoE) of a user equipment with respect to the cost to the application server for providing a particular QoE. For example, if a user equipment requires a high QoE, the application server can be configured to assess the cost profile associated with the cache, and make a suitable assessment of the value of the use of the cache in order to provide the expected QoE.

According to embodiments, the cost profile can be indicative of the cost of cache usage which is dependent upon the level of latency that would be considered to be acceptable to an application server. For example, the cost of cache usage may be considered to be inversely proportional to an acceptable latency level to the application server. In this example, cache usage becomes more expensive as the acceptable latency level decreases. Furthermore, the latency level which is acceptable to a particular application server can have an impact on the selection of the type of data storage that may be used as cache storage. For example, data access speed and the resulting latency of the provision of this data can be dependent on the type of storage used, for example hard disk memory or flash memory or random access memory or other memory storage format as would be readily understood.

According to embodiments, the cost profile can provide different costs associated with a variety of different specific cache resource locations within the communication network. For example different locations of cache resources can have associated therewith particular latencies for the provision of requested data to user equipments in varying locations within the communication network. Additionally, different locations of cache locations can have associated therewith particular backhaul bandwidth costs for transferring the data from the application server to the cache at the particular cache location. A cost profile including parameters indicative of different cache resource locations can provide an application server with options for cache resource and associated costs. Furthermore, based on a cost profile and topology of a network, an application server may further determine that duplication of some data may be suitable.

According to embodiments, the application server can select particular data for storage in a cache, wherein this determination can be based on the history of requests for the particular data, perceived popularity of requests for this particular data, the importance of the speed by which the particular data is provided to the requesting user equipment or other parameters that may be used for the selection of appropriate data for cache storage. According to some embodiments, the importance of speed of delivery may be dependent on the size of the particular data, as a greater amount of data can take longer for transmission in particular when there are limitations or bottlenecks within the communication network. According to embodiments, perceived popularity of requests for this particular data can represented by how often the data is accessed, how many different user equipments request access to the data or other parameter that can provide a perceived popularity of the particular data.

According to embodiments, where to cache data that is requested for caching by an application server can be determined in a number of different manners. For example, the application server may have a proxy server with is operating within the communication network wherein this proxy server provides the identification of the cache location to be used. In another embodiment, the cost profile includes locations of cache and their associated costs, wherein the application server may have prior knowledge as to where caching may be desired within the communication network based on historical or predictive information relating to data requests, and the application server can select the cache that most economically attains a desired quality of experience for the user equipment. As would be readily understood, other mechanisms for the identification of cache location may be used and the above are examples and not intended to limit other potential cache location identification mechanisms.

The above detailed description describes potential cost tradeoffs between the use of cache storage and the backhaul network of a communication network for the provision of data requested by a user equipment from an application server. It is understood that the use of other network functions or network resources or both, may also have a potential cost tradeoff when compared to the use of the backhaul network for the provision of the user equipment requested data. For example, computations that are required for the provision of the requested data to a user equipment may be considered by an application server. In this example, the application server can receive a cost profile which is associated with locally (i.e. at the application server) performed computations and computations that are performed within the communication network, wherein where these computations are performed can impact the amount of backhaul bandwidth is needed for the provision of the requested data to the user equipment. Furthermore, cost profiles may be determined and provided to the application server for other network functions that can include compression and decompression functions, deep packet inspection functions or other network packet filtering functions. Having regard to compression/decompression functions, there may be a backhaul network saving if the requested data is compressed in advance of transmission over the backhaul, however, a communication network decompression function would need to be used to decompress this data in advance of provision to the user equipment, and as such an added cost can be associated with the communication network providing this function.

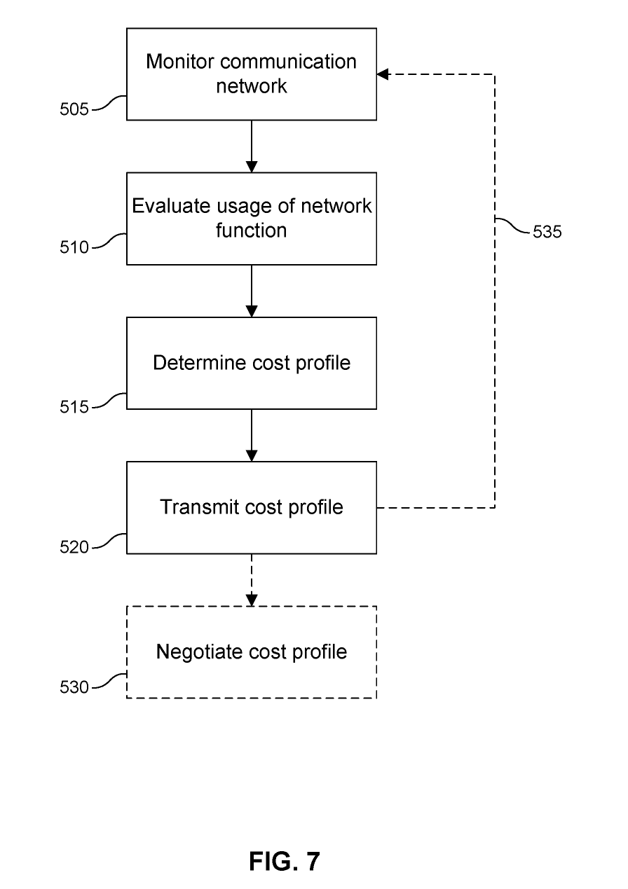

FIG. 7 illustrates a method for evaluating use of a network function in a communication network, in accordance with embodiments of the present invention. This method is defined based on actions that can be performed by a network function management function, which can be considered to be synonymous with a cache management function as described in other embodiments. The method includes monitoring 505 the communication network to determine network operational parameters and evaluating 510 usage of a network function associated with the communication network to determine network function usage parameters. The method further includes determining 515 a cost profile for network function usage, wherein the cost profile based at least in part on the network operational parameters or network function usage parameters or both and transmitting 520 the cost profile for network function usage.

According to embodiments and with further reference to FIG. 7, the method further includes the repeating 535 of the monitoring of one or more of the communication network and the evaluation of network function usage. This repeated monitoring and evaluating can result in the network function management function determining updated operational parameters or network function usage parameters which may be used for the determination of an updated cost profile. This updated cost profile can subsequently be provided to the application server in order to further determination of whether use of a particular network function is desired thereby.

According to embodiments, the method further includes negotiating 530 with the application server in order to determine a suitable cost profile that is acceptable. Negotiation between the application server and the network function management function can provide for adjustment to the cost profile based on considerations that may include user equipment requirements, the importance of use of the network function, history of use of the particular data that may be impacted by the network function or other factors as would be readily understood by a worker skilled in the art.

According to embodiments, the network function management component utilizes real computer resources or virtual computer resources or both, in order to provide the functionality of a network function management function (NFMF). It is understood that such computer resources utilize, at a hardware level, a set of one or more microprocessors operatively coupled to a corresponding set of memory components which include stored program instructions for execution by the one or more microprocessors.

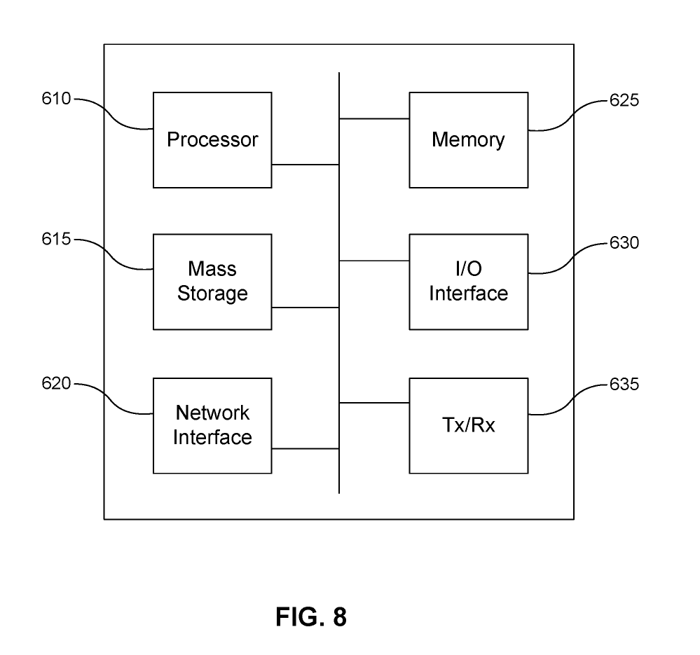

FIG. 8 is a schematic diagram of a hardware device that may for example, comprise one or more of nodes, functional entities of the communications system, a cache management component and a network function management component. In addition, the hardware device can be configured to perform any or all of steps of the above methods and features described herein, according to different embodiments of the present invention. As shown, the device includes a processor 610, memory 625, non-transitory mass storage 615, I/O interface 630, network interface 620, and a transceiver 635, all of which are communicatively coupled via bi-directional bus. According to certain embodiments, any or all of the depicted elements may be utilized, or only a subset of the elements. Further, device may contain multiple instances of certain elements, such as multiple processors, memories, or transceivers. Also, elements of the hardware device may be directly coupled to other elements without the bi-directional bus.

The memory may include any type of non-transitory memory such as static random access memory (SRAM), dynamic random access memory (DRAM), synchronous DRAM (SDRAM), read-only memory (ROM), any combination of such, or the like. The mass storage element may include any type of non-transitory storage device, such as a solid state drive, hard disk drive, a magnetic disk drive, an optical disk drive, USB drive, or any computer program product configured to store data and machine executable program code. According to certain embodiments, the memory or mass storage may have recorded thereon statements and instructions executable by the processor for performing any of the aforementioned method steps described above.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. Moreover, in some instances the present invention has been described using reference to terminology specific to LTE or other communication standard, it is readily understood that the use of these terms is meant to be illustrative and not limiting. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for caching in a communication network, the method comprising:
transmitting, by a cache management component, a cost profile indicative of one or more of a cost associated with cache usage and a cost associated with communication link usage.

2. The method according to claim 1, further comprising receiving, at the cache management component, one or more of network operational parameters indicative of utilization of a communication link associated the communication network and cache usage parameters indicative of utilization of cache associated with the communication network.

3. The method according to claim 2, further comprising determining, by the cache management component, the cost profile based at least in part on one or more of the network operational parameters and the cache usage parameters.

4. The method according to claim 3, wherein the cost profile for cache usage is updated based at least in part on one or more of updated network operational parameters and updated cache usage parameters.

5. The method according to claim 1, wherein the cost profile for cache usage defines a fixed cost for cache usage or a varying cost for cache usage.

6. A method for caching in a communication network, the method comprising:
monitoring, by a cache management component, the communication network to determine network operational parameters;
monitoring, by the cache management component, usage of cache associated with the communication network to determine cache usage parameters;
determining, by the cache management component, a cost profile for cache usage, the cost profile based at least in part on one or more of the network operational parameters and the cache usage parameters; and
transmitting, by the cache management component, the cost profile for cache usage.

7. The method according to claim 6, wherein one or more of the monitoring the communication network and monitoring the usage of cache, is repeated thereby obtaining one or more of updated network operational parameters and updated cache usage parameters.

8. The method according to claim 7, wherein the cost profile for cache usage is updated based at least in part on the updated network operational parameters or the updated cache usage parameters or both.

9. The method according to claim 6, wherein the cost profile for cache usage defines a fixed cost for cache usage or a varying cost for cache usage.

10. The method according to claim 9, wherein the varying cost for cache usage can be dependent on one or more of an amount of data to be cached and a time frame for data to be cached.

11. The method according to claim 9, wherein the varying cost for cache usage can be dependent on the network operational parameters.

12. The method according to claim 11, wherein the network operational parameters are indicative of a cost associated with data transfer using a backhaul network.

13. The method according to claim 6, further comprising negotiating, by the cache management component, modifications to the cost profile.

14. A device for caching in a communication network, the device comprising:
a processor; and
machine readable memory storing machine executable instructions which when executed by the processor configure the device to:
monitor the communication network to determine network operational parameters;
monitor usage of cache associated with the communication network to determine cache usage parameters;
determine a cost profile for cache usage, the cost profile based at least in part on one or more of the network operational parameters and the cache usage parameters; and
transmit the cost profile for cache usage.

15. A method for caching in a communication network, the method comprising:
receiving, by an application server, a cost profile for cache usage, the cost profile indicative of one or more of network operational parameters associated with the communication network and cache usage parameters indicative of usage of cache associated with the communication network; and
determining if caching of data is required, wherein determining is based at least in part on the cost profile.

16. The method according to claim 15, further comprising receiving, by the application server, an updated cost profile for cache usage.

17. The method according to claim 15, further comprising transmitting, by the application server, a request for cache when a determination has been made that caching of data is required.

18. A device for evaluating caching in a communication network, the device comprising:
a processor; and
machine readable memory storing machine executable instructions which when executed by the processor configure the device to:
receive a cost profile for cache usage, the cost profile indicative of one or more of network operational parameters associated with the communication network and cache usage parameters indicative of usage of cache associated with the communication network; and
determine, by the application server, if caching of data is required, wherein determining is based at least in part on the cost profile.

19. A method for evaluating use of a network function in a communication network, the method comprising:
transmitting, by the network function management component, a cost profile indicative of a cost associated network function usage.

20. The method according to claim 19, further comprising:
monitoring, by the network function management component, the communication network to determine network operational parameters; and
evaluating, by the network function management component, usage of the network function associated with the communication network to determine network function usage parameters;
determining, by the network function management component, the cost profile based at least in part on one or more of the network operational parameters and network function usage parameters.
